(19) United States
(12) Patent Application Publication
(10) Pub. No.: US 2018/0017892 A1
(43) Pub. Date: Jan. 18, 2018

(54) IMAGE FORMING APPARATUS

(71) Applicant: CANON KABUSHIKI KAISHA, Tokyo (JP)

(72) Inventor: Koji Shigehiro, Toride-shi (JP)

(21) Appl. No.: 15/646,179

(22) Filed: Jul. 11, 2017

(30) Foreign Application Priority Data
Jul. 15, 2016 (JP) 2016-140689

(51) Int. Cl. G03G 15/08

(52) U.S. Cl. CPC G03G 15/0825

(57) ABSTRACT

An image forming apparatus includes an image bearing member, a developing apparatus, and a controller. The developing apparatus includes a developer container, a developer bearing member, a conveyance member, and a detection unit. The detection unit comprises a detection surface arranged to face to the conveyance member and is configured to detect a toner density concerning the developer in the developer container and output a signal. The controller configured to adjust a toner density concerning the developer in the developer container based on a peak value of a waveform of an output signal of the detection unit.

### BACKGROUND OF THE INVENTION

### Field of the Invention

The present invention relates to an image forming apparatus such as a copying machine, a printer, a facsimile, or a multifunction machine having a plurality of such functions.

### Description of the Related Art

Hitherto, in an image forming apparatus adopting an electro-photographic system, an electrostatic latent image formed on a photosensitive drum serving as an image bearing member is developed in a developing apparatus using toner, by which a toner image is formed. Some developing apparatuses use a two-component developer containing nonmagnetic toner particles serving as toner and magnetic carrier particles serving as carrier as the developer. One example of such developing apparatus using the two-component developer is equipped with a toner density sensor serving as a detection unit configured to detect toner density in a developer container storing the developer (refer for example to Japanese Unexamined Patent Application Publication No. 2014-115548).

The developing apparatus is equipped with a conveyance member such as a screw configured to agitate and convey the developer in the developer container, and the toner density sensor is arranged to oppose to the conveyance member. Therefore, output signals of the toner density sensor vary according to the rotation of the conveyance member. Hitherto, the developing apparatus had been controlled based on a mean value of waveform of output signals of the toner density sensor varied as described above. However, the output of the mean value of the output signals may become unstable depending on the amount of developer in the developer container, and in some cases, toner density could not be detected accurately. Thus, there were demands for a method to detect toner density stably even if the amount of developer in the developer container is fluctuated.

### SUMMARY OF THE INVENTION

According to one aspect of the present invention, an image forming apparatus including an image bearing member, a developing apparatus comprising a developing apparatus configured to develop an electrostatic latent image formed on the image bearing member using toner, the developing apparatus comprising, a developer container configured to store developer including nonmagnetic toner and magnetic carrier, a developer bearing member configured to bear and convey the developer in the developer container, a conveyance member configured to convey the developer while agitating the developer within the developer container by rotating, and a detection unit comprising a detection surface arranged to face to the conveyance member and configured to detect a toner density concerning the developer in the developer container and output a signal, and a controller is configured to adjust a toner density concerning the developer in the developer container based on a peak value of a waveform of an output signal of the detection unit.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus according to a first embodiment.

FIG. 2 is a schematic configuration diagram extracting and illustrating a periphery of an image forming unit according to the first embodiment.

FIG. 3 is a schematic configuration diagram illustrated from an upper side with a portion of a developing apparatus omitted according to the first embodiment.

FIG. 4 is a schematic cross-sectional view of the developing apparatus and a replenishment device according to the first embodiment.

FIG. 5 is a cross-sectional view in which a left portion of FIG. 4 is enlarged.

FIG. 6 is a view illustrating an output waveform of an inductance sensor according to the first embodiment.

FIG. 7 is a block diagram of replenishment control of developer according to the first embodiment.

FIG. 8 is a view illustrating an output value based on a mean value of waveform of output signal of the inductance sensor.

FIG. 9A is a cross-sectional view illustrating a relationship between a conveyance screw and developer in a vicinity of the inductance sensor.

FIG. 9B is a vertical cross-sectional view illustrating a relationship between the conveyance screw and developer in the vicinity of the inductance sensor.

FIG. 10 is a flowchart determining an output value of inductance according to the first embodiment.

FIG. 11 is a view illustrating output values of inductance sensor according to a first comparative example and example 1.

FIG. 12 is a schematic configuration diagram illustrated from an upper side with a portion of a developing apparatus omitted according to a second embodiment.

FIG. 13 is a view illustrating a relationship between respective peak values of waveform of output signal of the inductance sensor and an amount of developer within a developer container according to a third embodiment.

FIG. 14 is a flowchart predicting an amount of developer within the developer container according to the third embodiment.

### DESCRIPTION OF THE EMBODIMENTS

### First Embodiment

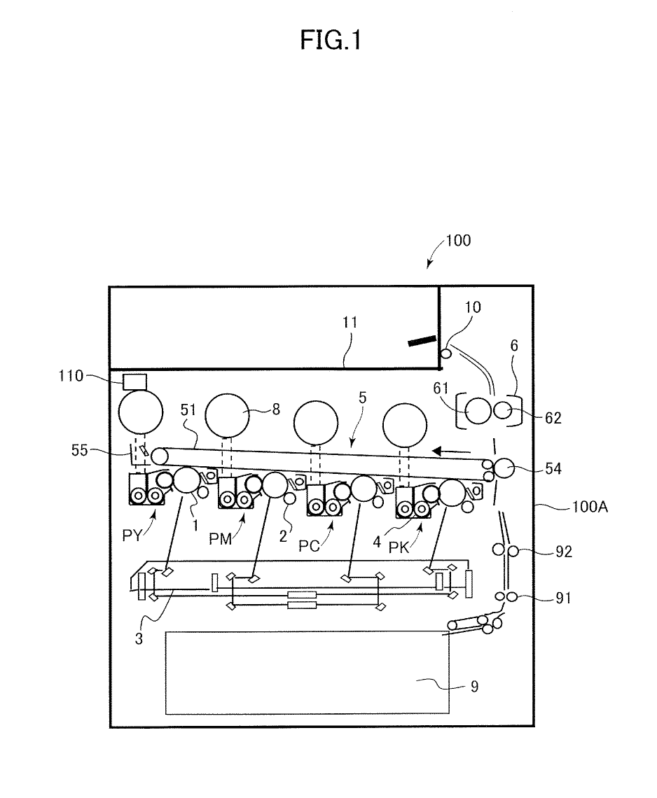

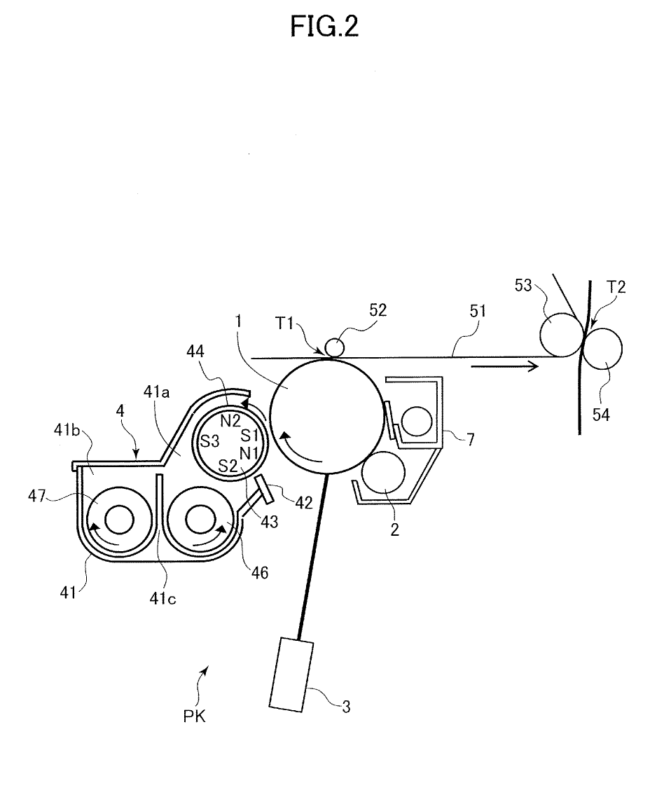

A first embodiment will be described with reference to FIGS. 1 through 11. First, a schematic configuration of an image forming apparatus according to the present embodiment will be described with reference to FIGS. 1 and 2.

### Image Forming Apparatus

An image forming apparatus 100 is a tandem-type full color image forming apparatus adopting an electro-photographic system. The image forming apparatus 100 includes first, second, third and fourth image forming units PY, PM, PC and PK respectively forming yellow, magenta, cyan and black images. The image forming apparatus 100 forms a toner image, i.e., image, corresponding to an image signal from a document reading apparatus (not shown) connected to an apparatus body 100A or a host device such as a personal computer connected in a communicatable manner to the apparatus body 100A, on a recording material. Paper, plastic films, cloths and other sheet materials are examples of the recording material.

The four image forming units PY, PM, PC and PK provided in the image forming apparatus 100 have similar configurations, except for the difference in developer color. Therefore, the image forming unit PK is described as a representative example, and description of other image forming units will be omitted.

A photosensitive drum 1, which is a cylindrical photoconductor serving as an image bearing member, is arranged in the image forming unit PK, as illustrated in FIG. 2. The photosensitive drum 1 is driven to rotate in a direction of the arrow in the drawing. A charging device, i.e., charging roller, 2 serving as a charging portion, a developing apparatus 4, a primary transfer roller 52 serving as a transfer member, and a cleaning device 7 serving as a cleaning unit are arranged in a circumference of the photosensitive drum 1. A laser scanner, i.e., exposing unit, 3 serving as an exposing portion is arranged at a lower side in the drawing of the photosensitive drum 1.

In FIG. 1, an intermediate transfer device 5 is arranged on an upper portion of the respective image forming units PY, PM, PC and PK. An endless intermediate transfer belt 51 serving as an intermediate transfer member is stretched across a plurality of rollers and configured to be driven in the direction of the arrow in the intermediate transfer device 5. As described later, the intermediate transfer belt 51 bears and conveys a toner image primarily transferred to the belt 51. As illustrated in FIG. 2, a secondary transfer roller 54 serving as a secondary transfer member is arranged at a position opposed to a roller 53, across which the intermediate transfer belt 51 is stretched, with the intermediate transfer belt 51 intervened, forming a secondary transfer portion T2 in which the toner image on the intermediate transfer belt 51 is transferred onto the recording material. As illustrated in FIG. 1, a fixing unit 6 is arranged downstream in a conveyance direction of recording material of the secondary transfer portion T2.

A cassette 9 storing recording materials is arranged at a lower portion of the image forming apparatus 100. The recording material fed from the cassette 9 is conveyed by a conveyance roller 91 toward a registration roller 92. A leading edge of the recording material abuts against the registration roller 92 in a stopped state and forms a loop, by which skew feed of the recording material is corrected. Thereafter, the registration roller 92 is started to be rotated at a matched timing with the toner image on the intermediate transfer belt 51, and the recording material is conveyed to the secondary transfer portion T2.

A process for forming a four-color full color image by the image forming apparatus 100 having the above-described configuration will now be described. At first, when an image forming operation is started, as illustrated in FIG. 2, a surface of the photosensitive drum 1 being rotated is charged uniformly by the charging device 2. Next, the photosensitive drum 1 is subjected to scan exposure by laser beams corresponding to image signals emitted from the exposing unit 3. Thereby, an electrostatic latent image corresponding to image signals is formed on the photosensitive drum 1. The electrostatic latent image on the photosensitive drum 1 is formed as an image by the toner stored in the developing apparatus 4, and becomes a visible image.

The toner image formed on the photosensitive drum 1 is primarily transferred to the intermediate transfer belt 51 at a primary transfer portion T1 formed between the primary transfer roller 52 arranged to nip the intermediate transfer belt 51. At this time, a primary transfer bias is applied to the primary transfer roller 52. Toner and other attachments remaining on the surface of the photosensitive drum 1 after primary transfer is removed by the cleaning device 7.

As illustrated in FIG. 1, this operation is performed sequentially in the respective image forming units PY, PM, PC and PK corresponding to yellow, magenta, cyan and black colors, and thereafter, the toner images of four colors are superposed on the intermediate transfer belt 51. Thereafter, at a matched timing with the formation of the toner image, the recording material stored in the cassette 9 is conveyed to the secondary transfer portion T2. Then, the four-color toner image on the intermediate transfer belt 51 is collectively secondarily transferred to the recording material by applying a secondary transfer bias to the secondary transfer roller 54. Toner and other attached matter remaining on the intermediate transfer belt 51 without being transferred at the secondary transfer portion T2 is removed by an intermediate transfer belt cleaner 55.

Next, the recording material is conveyed to the fixing unit 6 serving as a fixing portion. The fixing unit 6 includes a fixing roller 61 and a pressing roller 62, and the fixing roller 61 and the pressing roller 62 forms a fixing nip portion. The fixing roller can be a film or a belt, and the pressing roller can also be a belt. The recording material onto which the toner image has been transferred is passed through the fixing nip portion, by which the recording material is heated and pressed. Then, the toner on the recording material is melted and mixed, and fixed to the recording material as full-color image. Thereafter, the recording material is discharged by a sheet discharge roller 10 onto a sheet discharge tray 11. Thus, a sequence of image forming processes is ended.

The image forming apparatus 100 according to the present embodiment can form a single color image or a multicolor image using one or more of the image forming units of a desired color, such as a black-colored image.

### Developing Apparatus

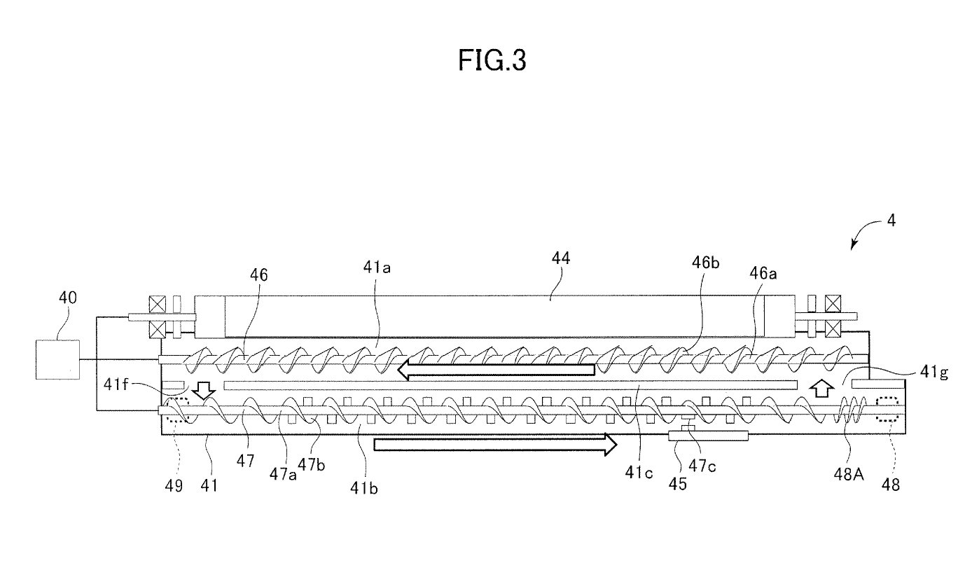

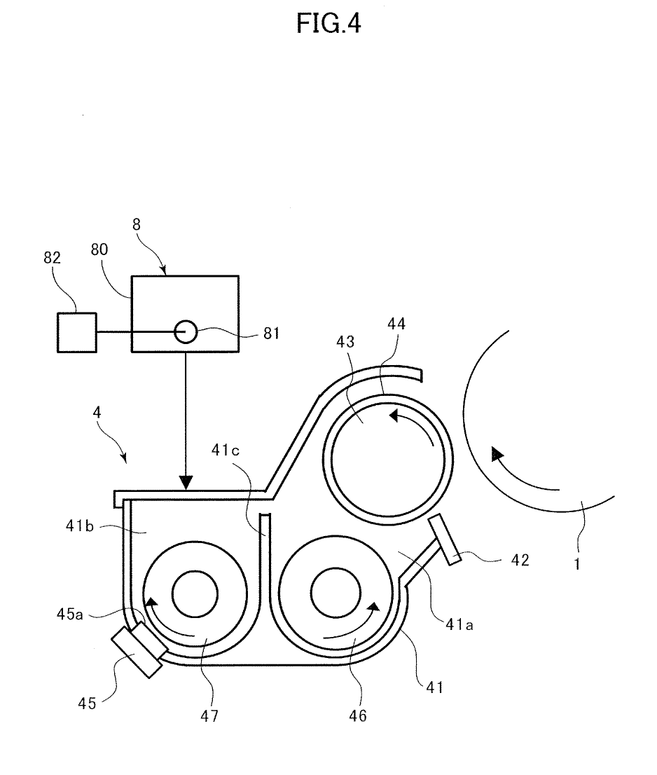

Next, the developing apparatus 4 will be described with reference to FIGS. 2 through 4. FIGS. 2 and 4 are cross-sectional views of the developing apparatus 4 taken at a plane orthogonal to an axial direction of the photosensitive drum 1 of FIG. 1. FIG. 3 is a plan view taken from an upper direction of FIG. 2 with a lid portion of the developing apparatus 4 omitted.

The developing apparatus 4 includes a developer container 41 storing a two-component developer (hereinafter called developer) including nonmagnetic toner particles (toner) and magnetic carrier particles (carrier) as main components. A portion of a developing area of the developer container 41 opposed to the photosensitive drum 1 is opened, and a developing sleeve 44 as developer bearing member is rotatably arranged in a manner partially exposed through the opening. A magnet roll 43 having a plurality of magnetic poles along a circumferential direction serving as a magnetic field generating portion is arranged non-rotatably with respect to the developer container 41 in the developing sleeve 44. The developing sleeve 44 is formed of a nonmagnetic material, and rotates in the direction of the arrow in FIGS. 2 and 4 during developing operation, bearing the developers from the developer container 41 in layers and conveying the same to the development area.

A developing chamber 41a and an agitating chamber 41b capable of storing the developer is formed in the developer container 41, wherein the developing chamber 41a and the agitating chamber 41b form a circulation path circulating the developer. The inner side of the developer container 41 is divided into the developing chamber 41a and the agitating chamber 41b by a partition wall 41c, and the developing chamber 41a and the agitating chamber 41b are communicated at both end portions in the longitudinal direction of the developer container 41 (left and right ends in FIG. 3) by communication ports 41f and 41g.

Further, a first conveyance screw 46 and the second conveyance screw 47 serving as conveyance members conveying developer are provided respectively in the developing chamber 41a and the agitating chamber 41b. Specifically, the first conveyance screw 46 is arranged in the developing chamber 41a, and the second conveyance screw 47 is arranged in the agitating chamber 41b. The first and second conveyance screws 46 and 47 are resin screws with helical blades (fins) 46b and 47b formed on a circumference of rotation shafts 46a and 47a. Further, as illustrated in FIG. 3, the second conveyance screw 47 includes a rib (paddle) 47c protruding in the radial direction at least at a position opposed to an inductance sensor 45 described later between one of the plurality of pitches of the blade 47b. In the present embodiment, the ribs 47c are provided on the second conveyance screw 47 at areas excluding both end sides of the screw 47. That is, the second conveyance screw 47 is provided with the blade 47b and ribs 47c as a plurality of projections having different developer conveyance capacities in the circumferential direction.

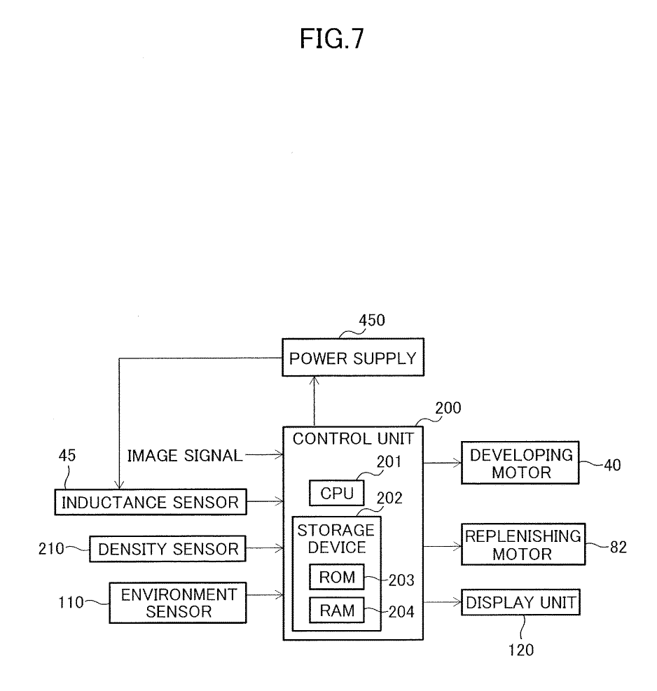

The developing sleeve 44 and the first and second conveyance screws 46 and 47 are arranged mutually in parallel with each other and in parallel with an axial direction of the photosensitive drum 1. The first and second conveyance screws 46 and 47 and the developing sleeve 44 are driven to rotate by a developing motor 40 serving as a driving unit. The developing motor 40 is controlled by a control unit 200 serving as a controller (refer to FIG. 7).

Along with this rotation, the developer in the developing chamber 41a moves toward a left side of FIG. 3 while being agitated by the first conveyance screw 46, and moves through the communication port 41f into the agitating chamber 41b. Further, the developer inside the agitating chamber 41b is moved toward a right side of FIG. 3 while being agitated by the second conveyance screw 47, and moves through the communication port 41g into the developing chamber 41a. In other words, the developer is conveyed in a circulated manner within the developer container 41 while being agitated by the two screws, which are the first and second conveyance screws 46 and 47.

The developer inside the developing chamber 41a is supplied via the first conveyance screw 46 to the developing sleeve 44, and a predetermined amount of the developer supplied to the developing sleeve 44 is borne on the developing sleeve 44 by the magnetic field generated by the magnet roll 43, and forms a developer reservoir. By the rotation of the developing sleeve 44, the two-component developer on the developing sleeve 44 passes the developer reservoir, where layer thickness of the developer is regulated by a regulation member 42, and the developer is conveyed to a developing area opposed to the photosensitive drum 1.

In the development area, the developer on the developing sleeve 44 is raised in a bristle state and forms magnetic bristles. By having the magnetic bristles contact the photosensitive drum 1 such that toner in the developer is supplied to the photosensitive drum 1, the electrostatic image on the photosensitive drum 1 is developed as toner image. Further, a developing bias in which DC voltage and AC voltage are superposed is applied to the developing sleeve 44 to improve developing efficiency, that is, to enhance an application rate of toner to the latent image. By the further rotation of the developing sleeve 44, the developer on the developing sleeve 44 after supplying toner to the photosensitive drum 1 is returned to the developing chamber 41a. Toner is consumed by the above-described developing step, and the developer in the developing chamber 41a in which the toner density is dropped is conveyed to the agitating chamber 41b.

A discharge port 48 through which a portion of a developer, excessive developer, within the developer container 41 is discharged is formed at a downstream end portion in the conveyance direction (right end portion of FIG. 3) of the second conveyance screw 47 on the agitating chamber 41b. Further, a return screw 48A conveying the developer in an opposite direction as the second conveyance screw 47 is provided upstream of the discharge port 48 on the downstream side of the second conveyance screw 47. Therefore, the developer conveyed within the agitating chamber 41b and moving beyond the return screw 48A is discharged through the discharge port 48. The discharge port 48 is opened downward, and the developer is discharged through the discharge port 48 by falling from the port. The developer discharged through the discharge port 48 is recovered in a recovery container not shown.

Meanwhile, a replenishing port 49 for replenishing toner from a replenishment device 8 (refer to FIG. 1) is provided on an upstream end in the conveyance direction (left end portion of FIG. 3) of the second conveyance screw 47 in the agitating chamber 41b. As illustrated in FIG. 1, replenishment devices 8 serving as replenishing portions are arranged on an upper portion of the developing apparatuses 4 of the respective image forming units PY, PM, PC and PK, for replenishing developer to each of the developer container 41 of the respective developing apparatuses 4. In the present embodiment, each replenishment device 8 stores a replenishment developer including toner and carrier. The replenishment device 8 is designed to replenish the replenishment developer through the replenishing port 49 of the developer container 41 into the agitating chamber 41b as needed, according to the amount of consumption of developer used in image forming, or the toner density of the developer in the developer container 41.

Specifically, as illustrated in FIG. 4, the replenishment device 8 includes a container 80 storing the replenishment developer, a replenishing screw 81 capable of conveying an amount of developer within the container 80 according to the number of rotation, and a replenishment motor 82 driving the replenishing screw 81. As a detection result of image ratio when forming an image, a detection result by an inductance sensor 45 described above, and a detection result of patch image density, the control unit 200 (refer to FIG. 7) controls the replenishment motor 82. That is, the replenishing screw 81 is rotated for a number of times corresponding to above-described detection result, for example, and replenishes the required amount of developer into the developer container 41. A patch image is a toner image used for control, wherein the patch image formed on the photosensitive drum 1 or the intermediate transfer belt 51 is detected by a density sensor 210 (refer to FIG. 7), based on which the control unit 200 adjusts the amount of developer in the developer container 41. For example, if the patch image density is lower than a threshold value, it is determined that an amount of toner charge is high, and developer is replenished from the replenishment device 8.

The replenishment developer replenished to the agitating chamber 41b is agitated and conveyed by the second conveyance screw 47 together with developer having a low toner density conveyed from the developing chamber 41a within the agitating chamber 41b. The excessive developer in the developer container 41 is discharged through the discharge port 48 as described above. At this time, carrier deteriorated through use is also discharged. As described, according to the present embodiment, replenishment developer including carrier is replenished from the replenishment device 8, and excessive developer containing deteriorated carrier is discharged through the discharge port 48, such that the carrier is replaced. In other words, a so-called ACR (Automatic Carrier Refreshment) method is adopted in the present embodiment.

### Developer

Now, the two-component developer including toner and carrier stored in the developer container 41 will be described in detail. Toner includes colored resin particles including binding resin, coloring agent, and other additives as needed, and colored particles in which colloidal silica fine powder and other external additives are externally added. Toner is a polyester resin having negative chargeability, preferably with a volume average particle size of 4 μm or greater and 10 μm or smaller. More preferably, the volume average particle size is preferably 8 μm or smaller.

Further, a surface-oxidized or non-oxidized iron, nickel, cobalt, manganese, chrome, rare-earth elements and other metals, alloys thereof, or ferrite oxide can be preferably used as the carrier, and the method for manufacturing such magnetic particles is not specifically restricted. The carrier has a weight average particle size of 20 to 60 μm, preferably 30 to 50 μm, and a resistivity of 10⁷Ω cm or greater, preferably 10⁸Ω cm or greater.

As for the toner used in the present embodiment, the volume average particle size was measured using a device and method described below. A SD-2000 sheath flow electric resistance particle counter (product of Sysmex Corporation) was used as the measurement apparatus. The measurement method is as described below. A 0.1 ml surfactant, preferably an alkyl benzene sulfonate, is added as dispersing agent to 100 to 150 ml of an electrolyzed water solution of 1% NaCl solution prepared using first class sodium chloride, and 0.5 to 50 mg of measurement sample is added thereto. The electrolyzed water solution in which the sample is suspended is subjected to distribute processing for 1 to 3 minutes in an ultrasonic distributor. Then, the above-mentioned SD-2000 sheath flow electric resistance particle distribution measurement apparatus is used to measure particle distribution of particles having a size of 2 to 40 μm using a 100-μm aperture as aperture, to acquire a volume average distribution. The volume average particle size is obtained through the volume average distribution acquired as above.

Further, the resistivity of carrier used in the present embodiment is measured using a sandwich-type cell having a measurement electrode area of 4 cm² and an interval between electrodes of 0.4 cm. An applied voltage E (V/cm) between electrodes is applied under pressure of 1 kg of weight on one electrode, and based on the current supplied to the circuit, the resistivity of the carrier was acquired.

### Inductance Sensor

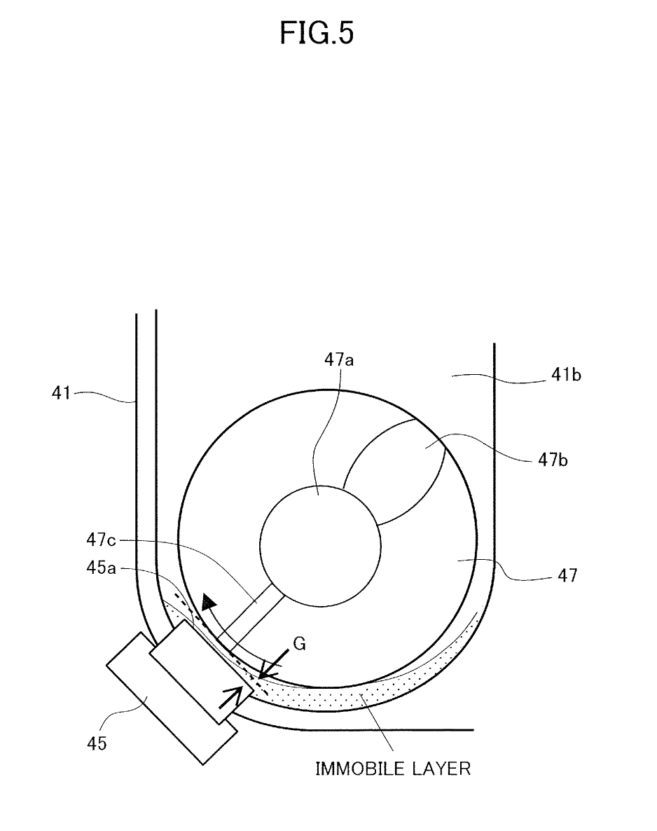

Next, the inductance sensor 45 serving as a detection unit is described in detail with reference to FIGS. 4 and 5. The inductance sensor 45 has a detection surface 45a exposed in the agitating chamber 41b. Then, the detection surface 45a is arranged to opposed to a portion in the circumferential direction of the second conveyance screw 47 within the agitating chamber 41b, and toner density within the developer container 41 is detected and a signal is output. That is, the inductance sensor 45 is arranged close to the second conveyance screw 47 in consideration of the agitation conveyance performance of the developer on the detection surface 45a.

In the present embodiment, the detection surface 45a is positioned lower than the rotation shaft 47a of the second conveyance screw 47. More specifically, the inductance sensor 45 is fixed to the developer container 41 such that the detection surface 45a is positioned near a bottom portion of the developer container 41.

If the distance between an outermost contour surface of the second conveyance screw 47 and the detection surface 45a of the inductance sensor 45 is referred to as G, distance G should preferably be approximately 0.2 to 2.5 mm. If the detection surface 45a is positioned too close to the second conveyance screw 47, the outermost contour surface of the second conveyance screw 47 contacts the detection surface 45a, and the detection surface 45a may be scraped by the rotation of the second conveyance screw 47. This may lead to deformation of the detection surface 45a, mixing of shaved chips into the developer container 41, or forming of aggregates by the developer being pressed between the detection surface 45a and the second conveyance screw 47, the aggregates causing image deterioration.

Meanwhile, if the detection surface 45a is separated for more than 2.5 mm from the second conveyance screw 47, the developer within a detection area of the inductance sensor 45 will not move, or the movement thereof is deteriorated. In other words, the detection area becomes an immobile layer. Therefore, the toner density that continuous to be refreshed and replaced by replenishment and consumption cannot be detected appropriately. In consideration of these research results, the distance G is set to 0.5 mm according to the present embodiment.

As described, magnetic carrier and nonmagnetic toner are main components of the developer. If a toner density T/D, that is, ratio of toner weight to developer weight, of the developer changes, a magnetic permeability determined by blend ratio of magnetic carrier and nonmagnetic toner is also changed. Therefore, the change of magnetic permeability is detected by the inductance sensor 45. The electric signals output from the inductance sensor 45 are varied approximately linearly according to toner density. That is, the electric signals output from the inductance sensor 45 correspond to toner density of the developer within the developer container 41. Therefore, the toner density within the developer container 41 can be detected by the inductance sensor 45.

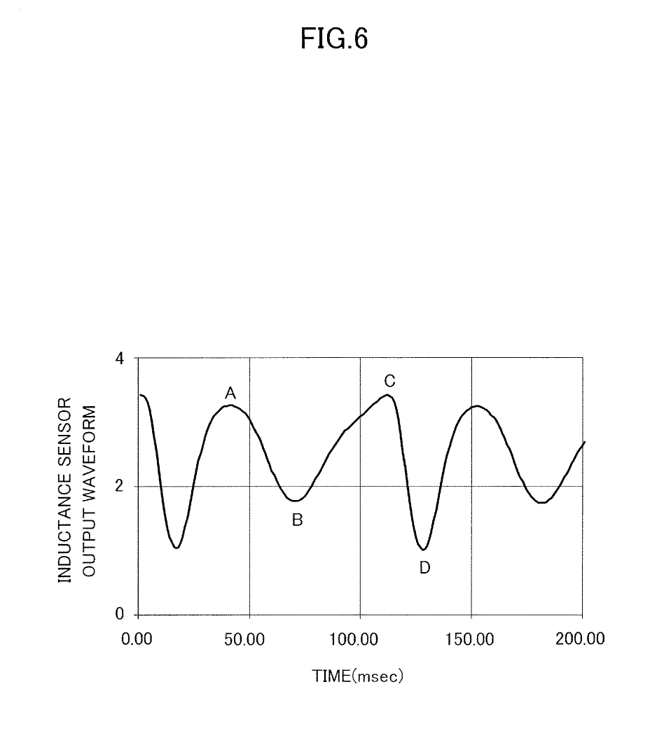

The inductance sensor 45 detects the magnetic permeability of carrier particles in the developer within a predetermined range from the detection surface 45a, such that the detected magnetic permeability is changed along with the movement of the second conveyance screw 47. Specifically, the developer passes the detection surface 45a of the inductance sensor 45 along the rotation cycle of the second conveyance screw 47. Therefore, the signal waveform, i.e., output signal waveform, of magnetic permeability detected by the inductance sensor 45 has a minimum value, i.e., peak value, and maximum value, i.e., peak value, mainly corresponding to a cycle and rotational speed of the blade 47b and the ribs 47c of the second conveyance screw 47, as illustrated in FIG. 6.

### Control Unit

Now, the control unit 200 configured to control respective portions of the image forming apparatus 100 will be described with reference to FIG. 7. The control unit 200 includes a CPU (Central Processing Unit) 201 and a storage device 202. The storage device 202 includes a ROM (Read Only Memory) 203 and a RAM (Random Access Memory) 204. A program corresponding to control procedure and the like are stored in the ROM 203. The CPU 201 executes control of various portions by reading programs. Further, working data and input data are stored in the RAM 204. The CPU 201 executes control by referring to the data stored in the RAM 204 based on the aforementioned programs and the like.

The actions of the developing motor 40 and the replenishment motor 82 described above or the output of the inductance sensor 45 and the density sensor 210 are controlled by the CPU 201 of the control unit 200. That is, the CPU 201 refers to the storage device 202 and controls the operations of the motors 40 and 82 based on output signals of various sensors 45 and 210. Further, as described above, the control unit 200 controls the replenishment motor 82 according to the image ratio when forming an image. The image ratio is computed by the CPU 201 based on image signals entered from the document reading apparatus or the host device.

The processing of output signals from the inductance sensor 45 will be described. The output signals from the inductance sensor 45 are temporarily stored in the storage device 202, and then transmitted to the CPU 201. Then, the CPU 201 compares a prescribed toner density, i.e., toner density according to the initial set value, stored in the storage device 202 with the toner density detected by the inductance sensor 45. Based on the result, the CPU 201 performs replenishment control of the developer, and executes a control to adjust the toner density within the developer container 41.

A charged amount of the developer in the developer container 41 by frictional charge is increased by being agitated by the first and second conveyance screws 46 and 47, and being coated on the developing sleeve 44 during image forming operation. The developer to seem coarsely powdered caused by repulsive electric field between toner and carrier and electrostatic aggregation causes the developer to be in a state containing an air layer and having increased volume, in other words, having lower bulk density. Meanwhile, in a case where the apparatus is left as it is for a long period of time after image formation had stopped and relative humidity within the developer container 41 is raised, the amount of frictional charge of the developer gradually drops. Therefore, the static repulsive electric field generated between toner and carrier is reduced, and the developer will be in a most densely filled state by its own weight, such that the volume of the developer is reduced, in other words, bulk density is increased.

Regarding the bulk density changed by the relative humidity or charged amount of the developer as described, a most appropriate detection result of the inductance sensor 45 can be obtained by correcting the voltage value entered to the inductance sensor 45 regarding T/D with the relative humidity value and the like. Therefore, the present embodiment provides an environment sensor 110 for detecting temperature and humidity within the apparatus body 100A. The CPU 201 computes the relative humidity based on the temperature and humidity detected by the environment sensor 110, and corrects the voltage value entered to the inductance sensor 45 from a power supply 450.

### Relationship of Detection Area of Inductance Sensor and Amount of Developer

Next, a relationship between the detection area of the inductance sensor 45 and the amount of developer will be described. As described, the inductance sensor 45 detects the toner density of developer by detecting the ratio of magnetic substance (carrier) within the detection area. If a sufficient developer exists in the detection area of the inductance sensor 45, the output result of the inductance sensor 45 is assumed to have appropriately detected the toner density of the developer at that point of time. In contrast, if the ratio of an air layer or nonmagnetic structure body (such as the resin blade 47b or ribs 47c) occupying the detection area of the inductance sensor 45 is increased, the ratio of magnetic substance in the detection area is reduced, regardless of the toner density. Therefore, the inductance sensor 45 outputs a signal indicating that the “toner density is high”, higher than the actual toner density.

### Comparative Example

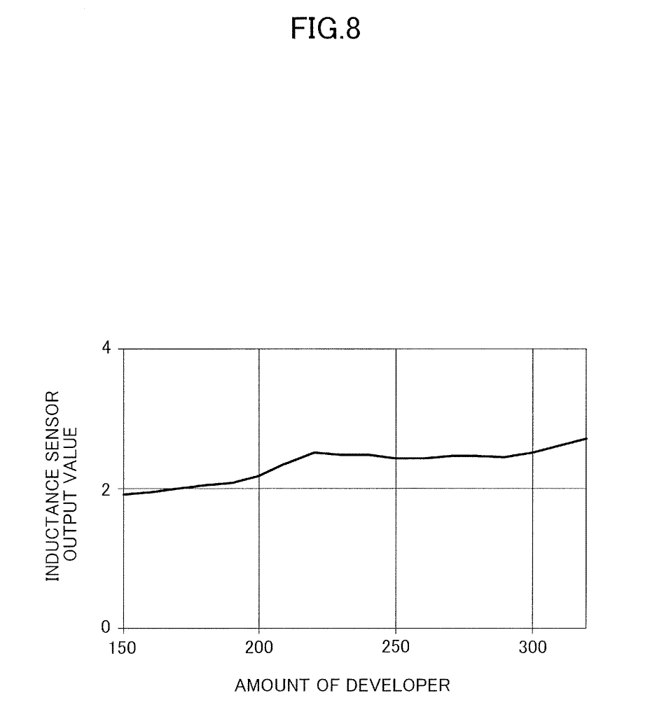

Now, in a case where a mean value of output signals of the inductance sensor 45 is set as the output value, the relationship between the output value and the amount of developer will be illustrated in FIG. 8. FIG. 8 illustrates an output value of the inductance sensor 45 of a case where the toner density is the same in the respective amounts of developer. Detection of magnetic permeability of the developer is performed every 10 ms by the inductance sensor 45. The detection of waveform is performed corresponding to one cycle of the second conveyance screw 47, that is, corresponding to a time required for the screw to rotate once based on the rotational speed, and the mean value is obtained and set as the output value of the inductance sensor 45. As illustrated in FIG. 8, the output value of the inductance sensor 45 is set small in an area where the amount of developer is small, the output value is constant in a vicinity of the center area of the amount of developer, and the output value is increased in the area where the amount of developer is high.

### Influence of Fluctuation of Amount of Developer on Toner Density Detection

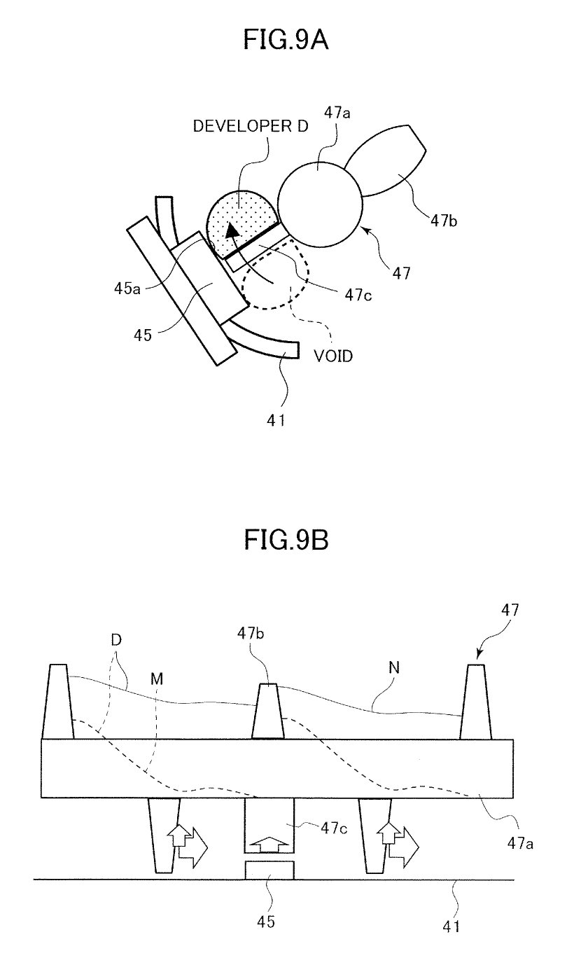

As described above, particulates such as the developer have a characteristic in that the volume is varied by the level or direction of behavior of the developer influenced by the structure member, such as the blade 47b or the ribs 47c, attached to the second conveyance screw 47. Further, the behavior of developer influenced by the blade 47b, serving as the second projection, and the ribs 47c, serving as the first projection, of the rotating second conveyance screw 47 is varied by the fluctuation of the amount of developer within the developer container 41. Therefore, the influence of the fluctuation of the amount of developer on the detection of toner density will be described with reference to FIGS. 9A and 9B.

As illustrated in FIG. 9A, in a state where the rib 47c passes a position opposed to the detection surface 45a of the inductance sensor 45, the developer D is conveyed at the downstream side in the direction of rotation of the rib 47c, and a void tends to form on the upstream side in the direction of rotation of the rib 47c where there is only a small amount of developer. Therefore, in a state where the blade 47b and the ribs 47c on the rotating second conveyance screw 47 agitate and covey the developer, the behavior of the developer in a vicinity of the inductance sensor 45 is varied as described below, depending on the amount of developer within the developer container 41.

At first, in a state where the amount of developer within the developer container 41 is small, and most of the surface of the developer D is lower than a center axis of the rotation shaft 47a of the second conveyance screw 47, as illustrated by broken line M, the distribution of the developer in the direction of conveyance of the second conveyance screw 47 is as follows. That is, the developer D is conveyed in a state being pushed by the downstream side surface in the conveyance direction of the blade 47b, and developer is distributed such that the amount of developer is smaller on the upstream side and greater on the downstream side of the blade 47b. According to such developer surface distribution, if the total amount of developer in the developer container 41 is reduced, the amount of developer in the vicinity of the ribs 47c is also reduced, and approximates an idle state where voids are formed upstream and downstream of the direction of rotation of the ribs 47c. Further, in that case, the amount of change of the bulk density is small, and a large amount of air layers is formed in the detection area of the inductance sensor 45.

Next, in a state where the developer surface of the developer D is on or above the rotation shaft 47a of the second conveyance screw 47, as illustrated by broken line N of FIG. 9B, developer behaves as follows. According to the behavior of developer, the rotation of the blade 47b and the ribs 47c causes the developer to be wound up at high speed, mixed with some air and behave in a more discrete manner. Therefore, the developer will be in a state containing a certain amount of air, but even if the amount of developer is varied, a certain volume can be stably obtained.

Meanwhile, if the amount of developer in the developer container 41 is so great that the developer surface of the developer D exceeds the peaks of the blade 47b and the ribs 47c of the second conveyance screw 47, the developer within the radius of rotation of the blade 47b and the ribs 47c receive the rotational force of the second conveyance screw 47. Therefore, the developer positioned above the radius of rotation of the blade 47b and the ribs 47c are not influenced by rotational force of the second conveyance screw 47. Further, as the developer surface height of the developer increases, the volume of the developer will be in a dense state even within the radius of rotation of the blade 47b and the ribs 47c due to the weight of the developer.

As described above, the output waveform of the inductance sensor 45 opposed to the second conveyance screw 47 having the blade 47b and the ribs 47c is as illustrated in FIG. 6. In FIG. 6, two maximum values and two minimum values of amplitude of output signals (signal values) of the inductance sensor 45 in FIG. 6 are respectively referred to as peaks A, B, C and D. Peak A is a peak on a side where the signal value is maximum, and corresponds to an area of the developer conveyed by the rib 47c. Peak B is a peak on a side where the signal value is minimum, corresponding to an area of the rib 47c and the void after the passing of the rib 47c. Peak C is a peak on a side where the signal value is maximum, corresponding to an area of the developer conveyed by the blade 47b. Peak D is a peak on a side where the signal value is minimum, and corresponds to an area of the blade 47b and an area after the passing of the blade 47b where the amount of developer is small.

In other words, regarding the output waveform of the inductance sensor 45, peak values (maximum values and minimum values) respectively appear before and after the rib 47c and the blade 47b have each passed an opposed position where they are opposed to the detection surface 45a. Then, in the output signal waveform of the inductance sensor 45 in which four peak values appear while the second conveyance screw 47 rotates once, the first to fourth peak values are defined as follows. At first, between the two peak values, i.e., peaks D and A, appearing between the rib 47c and the blade 47b, the peak value on the side of the rib 47c, i.e., side of the first projection, is set as a first peak value, i.e., peak A. The peak values appearing by the rotation of the second conveyance screw 47 from the first peak value, i.e., peak A, are sequentially set as a second peak value, i.e., peak B, a third peak value, i.e., peak C, and a fourth peak value, i.e., peak D.

Now, if an ACR-type developing apparatus 4 is used, as according to the present embodiment, carrier particles are replaced, such that the total amount of developer in the developer container 41 is fluctuated. That is, the amount of developer discharged through the discharge port 48 of the developing apparatus 4 is varied by the installation environment of the image forming apparatus 100, relative humidity, processing speed, or T/D and fluidity of the developer. The total amount of developer in the developer container 41 is fluctuated according to the amount of carrier included in the replenishment developer.

Therefore, in addition to factors such as rotational speed of the second conveyance screw 47 and the relative humidity, the output waveform of the inductance sensor 45 is varied by the fine deviation of the developer or the relationship of consolidation caused by the amount of developer being changed. That is, as illustrated in FIGS. 9A and 9B described above, the distribution and behavior of the developer differs according to the amount of developer within the developer container 41. Therefore, the output waveform of the inductance sensor 45 is also changed by the fluctuation of the amount of developer.

If the amount of developer in the developer container 41 is small, the signal value is most varied in the area of peaks A and B detected before and after the passing of the rib 47c. As illustrated in FIG. 9B, the developer distribution tends to be biased upstream in the direction of conveyance applying conveyance force to the developer within the pitch of the blade 47b of the second conveyance screw 47. Further, if the amount of developer is small, the deviation of distribution of surface height of the developer becomes significant, and if the amount of developer is high, the deviation of distribution of surface height of the developer is reduced.

Therefore, if the total amount of developer is small, the amount of developer carried by the rib 47c existing between the blade 47b conveying the developer in the rotational axis direction of the second conveyance screw 47 is small. Therefore, the amount of developer flowing into the space after the passing of the rib 47c is small, and a void is easily formed as illustrated in FIG. 9A, such that the signal value of the inductance sensor 45 becomes small. As the amount of developer increases, the developer is gradually caught by the rib 47c, and the signal value at peak A is increased. Moreover, if the amount of developer is increased, a void will not be easily formed after the passing of the rib 47c.

If the developer is further increased, the difference in developer surface between the rib 47c and the blade 47b is gradually reduced, and the output of the inductance sensor 45 tends to be increased as a whole. As described, by the behavior of the developer changing according to the amount of developer, the output value of the inductance sensor 45 is varied as illustrated in the comparative example of FIG. 8 described above. That is, in a certain area of the amount of developer, that is, near a center of the amount of developer, there is a stable region in which the output value of the inductance sensor 45 is rarely fluctuated with respect to the amount of developer. Meanwhile, there is a tendency where the output value is reduced monotonously as the developer reduces with respect to the stable region, and the output value is increased monotonously as the developer increases with respect to the stable region.

As described, the amount of developer inside the developer container 41 fluctuates according to the environment of outer air of the image forming apparatus 100, the charged amount of developer, the ratio of toner and carrier, deterioration by use, and the inclination of the image forming apparatus 100. Regarding these disturbances, combinations of various conditions exist in the market, and the amount of developer fluctuates in various situations. Therefore, it is preferable that the stable region as illustrated in FIG. 8 in which the output value of the inductance sensor 45 is stabilized with respect to the amount of developer is expanded.

### Toner Density Detection According to Present Embodiment

As described, if the amount of developer within the developer container 41 is small, the signal value of the inductance sensor 45 varies most significantly in the area of peaks A and B, i.e., first and second peak values, before and after the passing of the rib 47c. Specifically, at peak A, i.e., first peak value, before the passing of the rib 47c, the signal value of the inductance sensor 45 tends to be unstable if the amount of developer is small.

Meanwhile, as for peak C, i.e., third peak value, detected before passing of the blade 47b, the waveform of the signal value is rarely fluctuated from the region where there is a small amount of developer in the developer container 41 to the region where there is a large amount of developer. Since the conveyance force of the blade 47b is high in the rotational axis direction of the second conveyance screw 47 compared to the rib 47c, only a small amount of developer is spattered by the blade 47b, and the blade 47b holds and conveys the developer positioned below the rotation shaft 47a. Therefore, at peak C, the signal value is stabilized even if there is only a small amount of developer in the developer container 41. Therefore, the T/D can be detected accurately even if there is only a small amount of developer, by using the signal value of peak C.

Therefore, according to the present embodiment, toner density detection is performed as described below. In the present embodiment, a peak value of output signal waveform is used, instead of the mean value of output signals, as the output value of the inductance sensor 45 used for control. In other words, the toner density is detected using this peak value, and based on the detection result, the control unit 200 controls the developing motor 40 of the developing apparatus 4 and the replenishment motor 82 of the replenishment device 8 to adjust the toner density in the developer container 41. In other words, the developing motor 40 is driven to discharge the developer from the developer container 41 or the replenishment motor 82 is driven to replenish the developer into the developer container 41, such that the toner density of developer in the developer container 41 becomes appropriate. It is also possible to control either the replenishment of developer or the discharge of developer, based on the detection result of the inductance sensor 45.

It is preferable to use the peak value excluding peak A, i.e., first peak value, as the peak values of the output signal waveform of the inductance sensor 45 used for such control. In other words, it is preferable to use the peak values excluding the peak value, i.e., peak A, before the passing of the rib 47c from the peak values, i.e., peaks A and B, appearing before and after the passing of rib 47c, which is a projection having a highest conveyance capacity in the circumferential direction, of the position opposed to the inductance sensor 45.

Especially according to the present embodiment, the peak value used for the above-described control is the peak value, i.e., peak C, detected before the blade 47b passes the position opposed to the inductance sensor 45, out of the peak values, i.e., peaks C and D, appearing before and after the blade 47b passes this position. Hereinafter, the method for extracting and sampling peak values of the blade 47b in this position from the output signal waveform of the inductance sensor 45 will be described.

A predetermined control voltage is applied to the inductance sensor 45 from the power supply 450 having a rated voltage of 5 V, to obtain an output value corresponding to the magnetic permeability of the developer. In the present embodiment, if a highly magnetized particle-dispersed-type carrier particle is used, a sensor center output value of 2.5 V can be obtained by using a control voltage of approximately 4.7 V.

In a state where image formation is started, in the respective image forming units, at first, the photosensitive drum 1 and the intermediate transfer belt 51 start to rotate, high voltage for charging and developing image is applied, and the developing apparatus 4 starts to operate. In a state where the developing apparatus 4 starts to operate, the developer starts to be agitated by the first and second conveyance screws 46 and 47. The developer will be in a stabilized agitated state from the third rotation after the developer starts to be agitated by the first and second conveyance screws 46 and 47, so the signal values of the inductance sensor 45 for the first two rotations of the screw will not be recorded.

The output value of the inductance sensor 45 is sampled every 4 msec, and data corresponding to six cycles is temporarily stored in the storage device 202. Thereafter, sampling data is analyzed, and the peaks A, B, C and D of the waveform are determined. If the linear velocity of the photosensitive drum 1 is set to 245 mm/sec, the rotational speed of the second conveyance screw 47 serving as the conveyance member is 8.3 rps, and a single cycle of the screw is 120 msec. Therefore, by performing sampling at 4-msec intervals, 30 points are sampled while the screw rotates once. Since there are four peak values, i.e., peaks A, B, C and D, per one screw cycle, approximately seven points can be sampled per one amplitude including one peak.

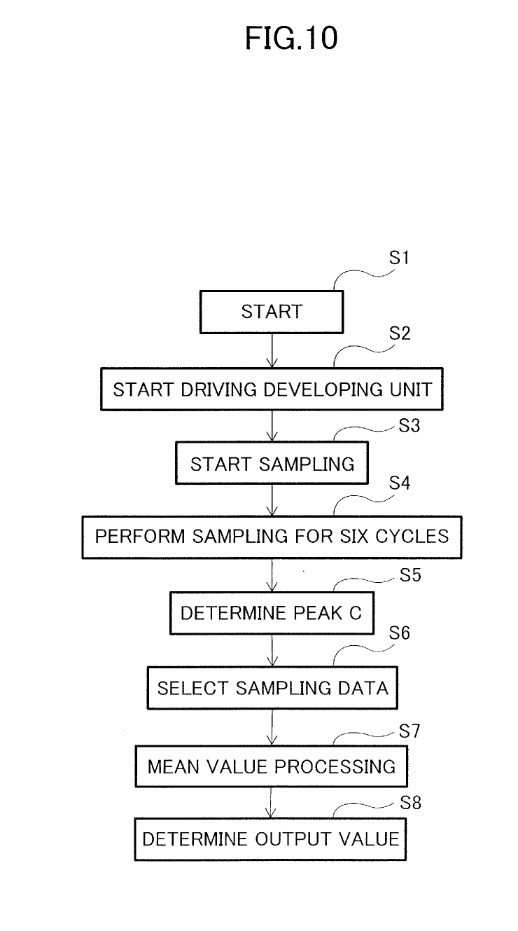

Now, the process will be described with reference to the flowchart of FIG. 10. The image forming operation is started (S1), and driving sequence of the developing apparatus 4 is started (S2). Thereafter, the control unit 200 starts to perform sampling from after 700 msec when the signal value of the inductance sensor 45 during pre-rotation is stabilized (S3). Pre-rotation refers to an operation performed in a preparation step prior to executing image formation, with the aim to perform stable driving of the photosensitive drum 1 and stabilization of charged potential, i.e., drum potential, on the surface of the photosensitive drum 1 by applying charge voltage, i.e., charge high voltage.

Further, the control unit 200 stores data corresponding to six cycles of sampling in the storage device 202 (S4). Based on the waveform data corresponding to six cycles stored in the storage device 202, the control unit 200 determines the first peak C by using data corresponding to one cycle for specifying the first waveform position (S5). That is, the control unit 200 determines the peak value, i.e., peak C, before the blade 47b passes the position opposed to the inductance sensor 45 based on the output signal waveform of the inductance sensor 45 when the second conveyance screw 47 had been rotated once.

After determining the peak position of the waveform by the first cycle, the earliest peak Cₙ₌₁ is determined, and the amplitude range of peak Cₙ₌₂ after one rotation from the peak Cₙ₌₁ is sampled. Specifically, seven points of sampling data taken every 4 msec, corresponding to 28 msec, are selected and extracted from the position of 111 msec of FIG. 6. Such selection of sampling data is performed for four cycles, from peak Cₙ₌₂ to peak Cₙ₌₅ (S6). Then, the mean of values taken before and after peak C during the four cycles is computed (S7) to determine the output value of the inductance sensor 45 (S8). That is, the peak value for determining the output value of the inductance sensor 45 is a mean value of peak values, i.e., peak values Cₙ₌₂ to Cₙ₌₅, of the same phase (before and after peak C) in a state where the second conveyance screw 47 had been rotated for a predetermined number of times, i.e., four turns.

The sampling data taken during the sixth cycle is a margin data in consideration of a case where the peak cannot be determined since the peak C of the waveform is stored at a read start position or the read end position of the storage device 202. Thus, only the magnetic permeability of the developer in the area conveyed by the blade 47b of the second conveyance screw 47 can be measured.

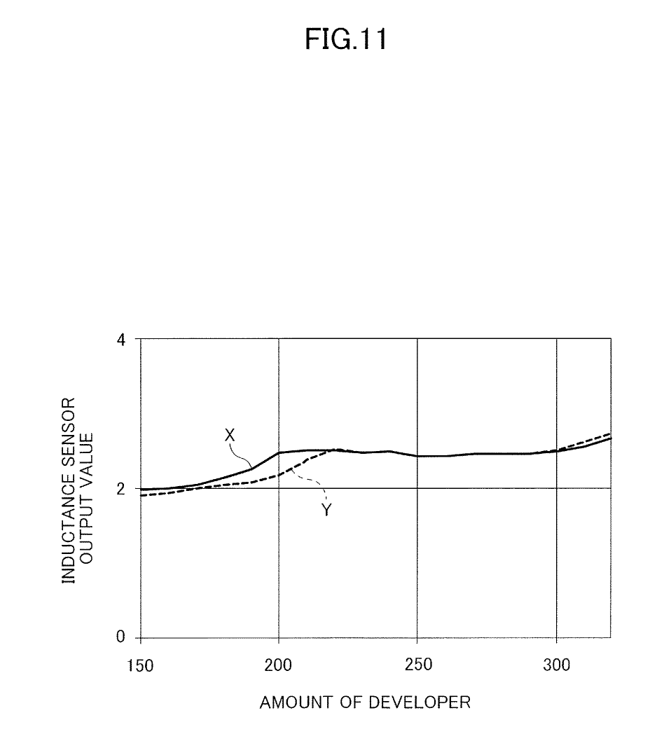

The output value of the inductance sensor 45 according to the present embodiment will be as illustrated by solid line X of FIG. 11. FIG. 11 illustrates a relationship between output value of the inductance sensor 45 and amount of developer in the developer container 41, and broken line Y illustrates the output value of the comparative example described earlier. Similar to FIG. 8, FIG. 11 illustrates an output value of the inductance sensor 45 of the case where the toner density is set equal in the respective amounts of developer.

As can be seen from FIG. 11, in the case of the present embodiment, a stable region not depending on the amount of developer is increased compared to the comparative example, and the T/D can be detected more stably. Especially if there is a small amount of developer, the stable region can be widened than the comparative example, such that the detection of T/D (toner density) can be performed stably even if there is a small amount of developer in the developer container 41.

In the example of the present embodiment, erroneous detection of T/D can be reduced even if the amount of developer in the developer container 41 fluctuates greatly. Therefore, even if the amount of developer in the developer container 41 fluctuates, or even if the height of the developer surface fluctuates, appropriate toner density control can be executed, and images having stable tones can be achieved for a long period of time.

### EXAMPLES

An actual result of experiments comparing the deviation of T/D of a case where the control according to the present embodiment is adopted and a control acquired as a mean value of all points of the waveform of the above-described comparative example will be described. In the experiment, the image forming apparatus 100 was tilted for 0.5 degrees such that the discharge port 48 of the developing apparatus 4 is positioned downward in a gravity direction, and images were formed on 100,000 sheets to confirm the transition of T/D.

As a result, in the case of the comparative example, the value finally detected by the inductance sensor 45 was deviated for 1.5% from the actual T/D. In contrast, there was a 0.7% deviation according to the control of the present embodiment. Further according to the comparative example, a void image caused by carrier attaching to the photosensitive drum 1 at the latter half of image forming operation had occurred.

As described, by adopting the control of the present embodiment, even if the amount of developer in the developer container 41 had fluctuated, the toner density can be detected in a stable manner. In other words, the present embodiment enables to provide an image forming apparatus in which the T/D during image forming operation can be detected correctly in a wide latitude, and a stable and high quality output image can be obtained.

In the above description, sampling data of peak C is used as an output value of the inductance sensor 45, but sampling data of another peak can be used, or multiple peak data can be used. That is, a peak having small change of signal value with respect to the fluctuation of the amount of developer can preferably be used.

However, the shape of the signal value waveform varies significantly according to the amount of developer in the area of the developer conveyed by a projection such as the rib 47c having a large conveyance force in the circumferential direction. Therefore, it is preferable to perform sampling excluding the area downstream in the direction of rotation of the projection having a large conveyance force in the circumferential direction as the cycle of sampling between structure bodies.

Further, the peak value of the output signal waveform of the inductance sensor 45 used for control depends on the shape of the conveyance member opposed to the detection surface of the inductance sensor 45. Therefore, depending on the shape of the conveyance member, a combination other than the blade 47b and the ribs 47c as described above can be adopted. For example, a screw having only the blade 47b can be adopted, or the ribs 47c can be positioned at multiple positions opposed to the detection surface. Therefore, the number of peak values during one rotation of the conveyance member is not restricted to four, depending on the shape of the conveyance member.

Moreover, a similar control is enabled even if an agitation auxiliary member, such as a Mylar™ or a magnet, is attached to the projection, such as the blade and ribs, on the conveyance member, as long as a signal waveform can be obtained for each structural body. A Mylar™ is a film-like member attached to the tip of the blade and ribs, and cleans by wiping the detection surface of the inductance sensor 45. Further, a magnet is similarly attached to the tip of the blade and ribs, forming magnetic bristles of the developer which is used to clean by wiping the detection surface of the inductance sensor 45.

### Second Embodiment

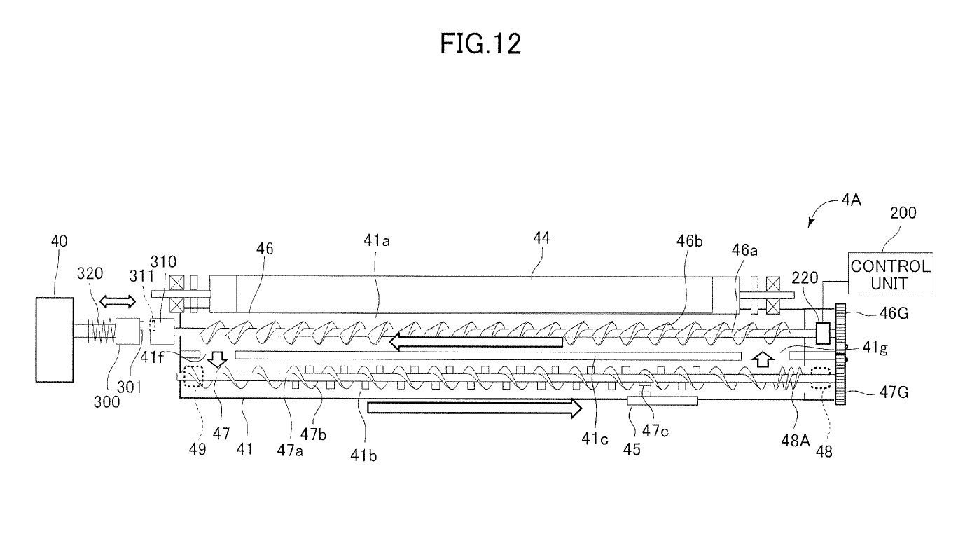

A second embodiment will be described with reference to FIG. 12 while referring to FIGS. 1 through 10. The sampling method of the inductance sensor 45 differs between the present embodiment and the first embodiment. The developing apparatus 4A of the present embodiment illustrated in FIG. 12 clarifies the configuration of driving the developing apparatus 4A from the developing motor 40 in comparison to the developing apparatus 4 illustrated in FIG. 3 of the first embodiment, but this drive configuration is similar to the first embodiment. Therefore, the configurations similar to the first embodiment are denoted with the same reference numbers and the descriptions thereof are either omitted or simplified, with only the portions that differ from the first embodiment or the portions not described in the first embodiment mainly described.

According to the present embodiment, a phase management of the second conveyance screw 47 is used as the sampling method adopted by the inductance sensor 45. A first coupling 300 is provided on the developing motor 40 serving as drive source for driving the developing apparatus 4A. The first coupling 300 is a body side driving coupling provided in the apparatus body 100A. Meanwhile, a second coupling 310 coupled to the first coupling 300 is provided on a downstream end in the conveyance direction of the developer on a rotation shaft 46a of the first conveyance screw 46. The second coupling 310 is a develop side driven coupling provided in the developing apparatus 4A.

Further, a drive gear 46G configured to transmit drive to the developing sleeve 44 and the second conveyance screw 47 is provided on an upstream end portion in the developer conveyance direction of the first conveyance screw 46. The first conveyance screw 46 and the developing sleeve 44 transmit the drive via an idler gear, and rotate in the same direction. The drive gear 46G of the first conveyance screw 46 is directly connected to a drive gear 47G provided on the downstream end in the developer conveyance direction of the second conveyance screw 47, and the first and second conveyance screws 46 and 47 are rotated in opposite directions. At this time, the phases of the drive gear 46G and the drive gear 47G are matched.

Further, a concave portion 311 is formed on an outer side in the radial direction from the center of rotation of the second coupling 310, and a convex portion 301 is formed on the first coupling 300. Then, the convex portion 301 is fit to the concave portion 311 by pressing the first coupling 300 toward the developer container 41 by a spring 320 with respect to the rotation shaft 46a. Thereby, the drive force of the developing motor 40 is transmitted via the first coupling 300 and the second coupling 310 to the first conveyance screw 46.

During initial setting or maintenance of the developing apparatus 4A, the phase of the first coupling 300 is constantly stopped at the same position, but the phase of the second coupling 310 is not necessarily synchronized with the first coupling 300. If the phases of the first and second couplings 300 and 310 are deviated, the rotation shaft of the developing motor 40 starts to rotate, and in a position where the phases of the convex portion 301 and the concave portion 311 correspond, the pressing force of the spring 320 causes the convex portion 301 and the concave portion 311 to fit to each other. Then, the rotation of the first and second couplings 300 and 310 are synchronized.

Further, a phase sensor 220 configured to detect the rotational direction phase of the rotation shaft 46a of the first conveyance screw 46 is provided. The phase sensor 220 is composed of a flag provided on the rotation shaft 46a, and a photo-interrupter configured to detect the flag. In the present embodiment, in a state where position of peak C of the output waveform of the inductance sensor 45 is opposed to the detection surface 45a of the inductance sensor 45, the flag is detected by the photo-interrupter, and the rotation of the second conveyance screw 47 is stopped. Therefore, the control unit 200 is configured to detect the phase of the peak C by the phase sensor 220.

In the present embodiment, similar to the first embodiment, the control unit 200 performs sampling of the signal values of the inductance sensor 45 every 4 msec. However, according to the present embodiment, data is stored in the storage device 202 after passing of 131 msec when sampling can be performed from peak C after the second conveyance screw 47 had been rotated for two rotations. In other words, the rotation of the second conveyance screw 47 is started from the position in which the position of peak C is opposed to the detection surface 45a of the inductance sensor 45. Since it takes 120 msec for the screw 1 to rotate once, 131 msec after starting of rotation corresponds to a position where the peak C of the second cycle had passed.

As for the sampling method, sampling is performed for four times, every 120 msec from the sampling start point, at seven points per one amplitude including peak C. Then, the mean of the sampling values is obtained and set as the output value of the inductance sensor 45.

According to the present embodiment, similar to the first embodiment, an output value such as solid line X of FIG. 11 is obtained. Therefore, in the case of the present embodiment, a stable region not dependent on the amount of developer is increased compared to the case of the comparative example, enabling T/D to be detected more stably. Especially in a state where there is a small amount of developer, the stable region can be expanded compared to the comparative example, such that the T/D (toner density) can be detected stably even if there is a small amount of developer in the developer container 41.

According to the first embodiment described above, the amount of use of memory of the storage device 202 is increased, and the amount of processing performed for analysis is increased, whereas according to the present embodiment, the amount of processing can be reduced. However, according to the present embodiment, the amount of use of memory or the processing time can be suppressed, but there is a limitation in the hardware configuration such as the phase sensor 220, while according to the first embodiment, such hardware configuration can be omitted. In the present embodiment, a photo-interrupter is used as the hardware configuration, but a configuration can also be adopted in which a stepping motor is used as the developing motor 40 to manage the phase.

### Third Embodiment

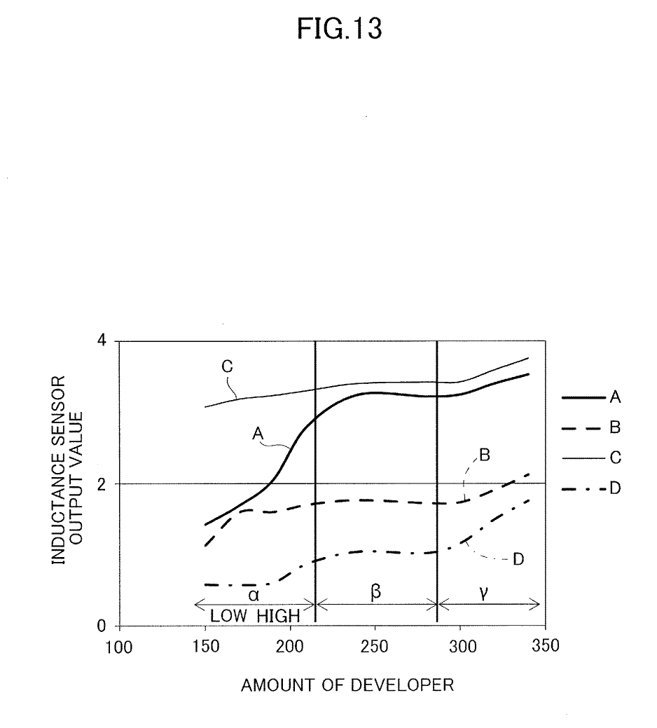

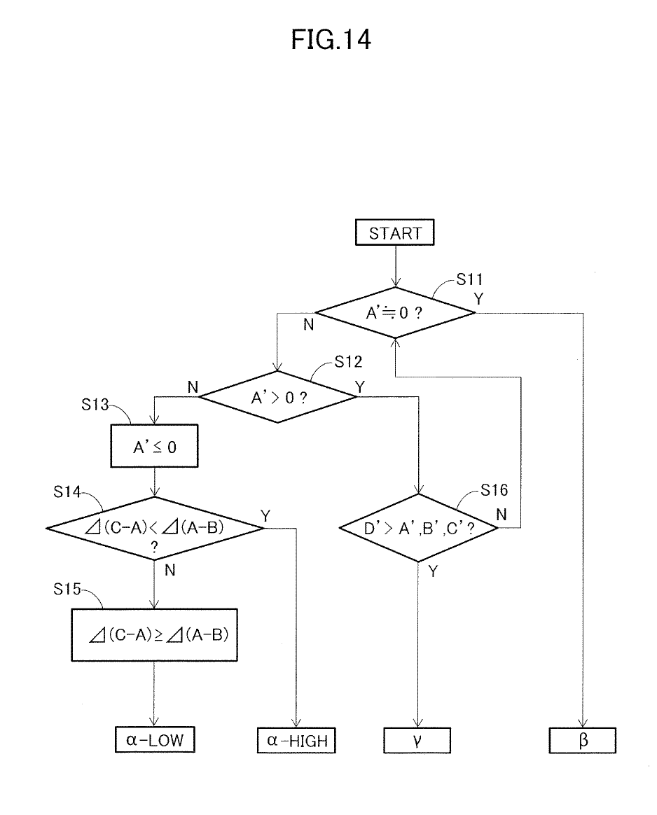

A third embodiment will be described with reference to FIGS. 13 and 14 while referring to FIGS. 1 through 10. In the present embodiment, the amount of developer in the developer container 41 is estimated from the output value of the inductance sensor 45 of the first embodiment. The configuration similar to the first embodiment is denoted with the same reference numbers, the descriptions thereof are omitted, and mainly the portions that differ from the first embodiment are described below.

As described above, in the case of the ACR-type developing apparatus 4, the amount of developer being stored is varied sequentially, depending on the installation environment or the image forming condition. If the amount of developer in the developer container 41 becomes excessively small, the developer surface of the developer stored in the developing chamber 41a is lowered, and the amount of supply of developer to the developing sleeve 44 is reduced. A loading amount, i.e., weight per unit area, of the developer in the development area opposed to the photosensitive drum 1 after the developer had been coated in a thin layer on the developing sleeve 44 is reduced. As a result, at first, an oblique pitch-like thin coating irregularity occurs to the blade 46b of the first conveyance screw 46, and finally, the coating is thinned and the image density is deteriorated. Thereby, attachment of carrier is increased, and a void may be formed on the image.

Meanwhile, if the amount of developer in the developer container 41 is increased excessively, the developer may leak from the developer container 41 through a gap between the developer container 41 and respective members. Further, the surface height of the developer may be raised, and the developer removed from the developing sleeve 44 may be supplied to the developing sleeve 44 without being agitated again in the developing chamber 41a, and density irregularity of the image may occur. Further, the amount of developer not subjected to conveyance force from the first and second conveyance screws 46 and 47 is increased, and specifically, the developer retained at a bearing portion supporting the ends of the first and second conveyance screws 46 and 47 is exposed to friction for a long time. The generated frictional heat may cause toner to aggregate or solidity, by which the movement of the first and second conveyance screws 46 and 47 may be obstructed and the rotation may be locked.

Therefore, according to the present embodiment, the amount of developer in the developer container 41 is estimated to perform appropriate control of the developing apparatus 4. As described in the first embodiment, if a plurality of projections exist in the circumferential direction of the second conveyance screw 47, the output waveform of the inductance sensor 45 will be influenced by the positional relationship of the projection and the abutting angle with respect to the developer. Thus, there may be portions where the signal value is not changed significantly in accordance with the amount of developer, and there may be portions where the signal value is changed significantly in accordance with the amount of developer. Therefore, according to the present embodiment, similar to the first embodiment, the peak value of the output signal waveform of the inductance sensor 45 is used to detect toner density, while the transition of change of the amount of developer is estimated based on the positional relationship of the respective peak values, i.e., peaks A, B, C and D.

In other words, the control unit 200 estimates the amount of developer in the developer container 41 based on the four peak values, i.e., peaks A, B, C and D, in the output signal waveform of the inductance sensor 45. The four peak values correspond to peak values that appear before and after the rib 47c serving as the first projection passes the opposed position opposed to the detection surface 45a, and before and after the blade 47b serving as the second projection passes the opposed position.

FIG. 13 illustrates the change of signal values of the respective peaks A, B, C and D in accordance with the amount of developer. The graph of FIG. 13 is divided into three regions, which are regions α, β and γ, wherein region β illustrates an area of the amount of developer where the output value of the inductance sensor 45 adopting the ACR method is stable. Meanwhile, region α is an area of the amount of developer where the amount of developer is reduced compared to region β and the output value of the inductance sensor 45 drops. Region γ is an area of the amount of developer where the amount of developer is increased compared to region β and the volume is increased such that the developer becomes dense and the output value of the inductance sensor 45 is increased.

As can be seen clearly from FIG. 13, the signal value is most greatly influenced by the change of the amount of developer when the developer carried up by the rib 47c passes the detection area of the inductance sensor 45, i.e., peak A of the signal waveform. Further, the signal value is also greatly influenced, subsequent to peak A, at peak D after passing of the blade 47b and at peak B after passing of the rib 47c. The portion of the developer conveyed by the blade 47b, corresponding to peak C, is the point where the amount of change is smallest with respect to the amount of developer, as have been described in the first embodiment.

The area where the change of signal value is great if the amount of developer is very small is the area after passing of the rib 47c, i.e., at peak B, but this change becomes very little if the amount of developer is increased. In contrast, after passing of the blade 47b, i.e., at peak D, the change is very little if the amount of developer is very small, and if the developer is increased, the signal value is gradually increased and passes a small flat region, but the signal value is increased monotonously if the amount of developer is significantly increased. The waveform of the developer carried up by the rib 47c, i.e., at peak A, tends to have a change of signal value that is greater than other peaks as the amount of developer increases from a small state.

In the present embodiment, with respect to the increase or decrease of the developer, whether the present region is region β is determined based on the amount of change of peak A whose signal value is changed significantly. Then, the change of the amount of developer is determined by comparing the values of peaks A, B and D with respect to peak C, setting the value of peak C having a small change in signal value with respect to the change of the amount of developer as reference, and control is performed such that the amount of developer is controlled to a region where the signal value of the inductance sensor 45 is flat.

As described, according to the present embodiment, the values of the respective peaks A, B, C and D are detected and compared to estimate the transition of the amount of developer, and control is performed to the developing apparatus 4 such that the amount of developer in the developer container 41 is maintained in region β. That is, if it is estimated that the amount of developer in the developer container 41 is small, the control unit 200 can execute a control to reduce the amount of developer discharged from the developer container 41. Meanwhile, if it is estimated that the amount of developer in the developer container 41 is great, the control unit 200 can execute a control to increase the amount of developer discharged from the developer container 41.

The control is described in detail with reference to the flow of FIG. 14. In the drawing, the amounts of change A′, B′, C′ and D′ are set as the amount of change per forming of images of a predetermined number of sheets n of respective peaks A, B, C and D. That is, the control unit 200 performs sampling of peaks A, B, C and D from the output signal waveform of the inductance sensor 45 at a certain point of time, and stores the result in the storage device 202. The respective values at this time are referred to as A₁, B₁, C₁ and D₁. After a predetermined number, i.e., n sheets, of images are formed from this point of time, the values of peaks A, B, C and D are subjected to sampling from the output signal waveform of the inductance sensor 45. The respective values at this time are referred to as Aₙ₊₁, Bₙ₊₁, Cₙ₊₁ and Dₙ₊₁. Then, the differences between A₁, B₁, C₁ and D₁ stored in the storage device 202 and Aₙ₊₁, Bₙ₊₁, Cₙ₊₁ and Dₙ₊₁ are set as amounts of change A′ (Aₙ₊₁−A₁), B′ (Bₙ₊₁−B₁), C′ (Cₙ₊₁−C₁) and D′ Dₙ₊₁−D₁).

The predetermined number of sheets n can be set arbitrarily to a number equal to or smaller than 800 sheets, such as 100 sheets or 200 sheets. That is, according to the present embodiment, the amount of developer in the developer container 41 is estimated based on long-term variation of output signal of the inductance sensor 45. For example, if assuming that 10% (weight ratio) of the developer being replenished is the carrier, the amount of carrier is increased 10 g after forming an image having an image ratio of 10% to 4000 sheets. Generally, image is often formed continuously with an image ratio of approximately 50% at highest, but even in that case, the amount of carrier is increased 10 g after forming images to 800 sheets. If it is assumed that an image having a 100% image ratio is formed continuously, the amount of carrier will be increased 10 g after forming images to 400 sheets. Therefore, according to the present embodiment, the output signal of the inductance sensor 45 is subjected to sampling and the amount of variation is computed at least every 800 sheets of continuous printing or less, preferably every 400 sheets or less, more preferably every 200 sheets or 100 sheets.

At first, whether the amount of change A′ of peak A is approximately 0 is determined (S11). The region where the amount of change A′ is flat, that is, the amount of peak A is almost unchanged, i.e., A′ is approximately 0, is region β, as illustrated in FIG. 13. Therefore, in a state where A′ is approximately 0, the control unit 200 determines that the amount of developer in the developer container 41 is region β. That is, it determines that the amount of developer in the developer container 41 is in a predetermined range which is the appropriate range.

Next, whether the amount of change A′ of peak A is greater than 0 (A′>0) is determined (S12), and if the amount of change A′ is smaller than 0 (A′<0) (S13), the difference of peak A and peak B and the difference of peak C and peak A are compared (S14). In other words, it is determined whether a predetermined condition is satisfied, in which the amount of change A′ of peak A after forming images to a predetermined number of sheets n is negative, and an absolute value of difference of peak A and peak B at that time (Δ|A−B|) is greater than the absolute value of difference of peak A and peak C (Δ|C−A|). The values of peaks A, B and C at that time are the values of the point of time when the amount of change A′ is computed, that is, the point of time when images are formed on the predetermined number of sheets s from a certain point of time. The same applies to the following description.

If Δ|C−A|<Δ|A−B| (S14: Y), the control unit 200 determines that the amount of developer in the developer container 41 is in a state transiting from region β to region α (α-high). That is, it estimates that the amount of developer in the developer container 41 is smaller than the predetermined range. Meanwhile, if the absolute value of difference between peak A and peak B is equal to or smaller than the absolute value of difference between peak A and peak C (Δ|C−A|≧Δ|A−B|) (S15), the control unit 200 determines that the amount of developer in the developer container 41 is even smaller (α-low). In FIG. 14, the absolute value is not shown, but the magnitude relation of respective signal values of FIG. 14 is C, A, B and D in the named order in descending order, such that (C−A) and (A−B) are positive values, and they are the same as absolute values.

Meanwhile, if the amount of change A′ of peak A is greater than 0 in S12 (A′>0), the amounts of change A′, B′, C′ and D′ of the respective peaks are compared. That is, whether the amount of change A′ is positive and whether the amount of change D′ of peak D after forming images to the predetermined number of sheets n is greater than the amounts of change A′, B′ and C′ of peaks A, B and C after forming images to the predetermined number of sheets n (D′>A′, B′ and C′) is determined (S16). If D′>A′, B′ and C′, the control unit 200 determines that the state is region γ in which the amount of developer in the developer container 41 is high. That is, the control unit 200 estimates that the amount of developer in the developer container 41 is greater than the predetermined range.

As illustrated in FIG. 13, if the signal values of all peaks A, B, C and D tend to increase, and especially, the increase rate of the value of peak D is higher than the other peaks A, B and C, it can be determined that the amount of developer is increased, instead of determining that the T/D is reduced. Peak D corresponds to the peak of detecting the area immediately after the passing of blade 47b, and if the amount of developer is increased, the ability to move the developer strongly upward as in the case of the rib 47c is not so high. Therefore, the void that is created after the passing of the blade 47b is small, and if the amount of developer is increased, the surrounding developer easily moves into the void, such that the sensitivity of increase of developer is high with respect to the increase in signal value. Therefore, it can be determined that the amount of developer in the developer container 41 is greater than the predetermined range, by setting the amount of change of peak D as reference.

Next, we will describe the control of the developing apparatus 4 in the respective regions. In the case of region β, it is determined that the amount of developer in the developer container 41 is appropriate, and no control is performed to increase or decrease the amount of developer in the developer container 41.

At first, if a predetermined condition, i.e., first condition, of region α-high, that is, A′<0 and Δ(C−A)<Δ(A−B), is satisfied, the control unit 200 executes control to reduce the amount of developer discharged from the developer container 41 compared to when a first condition is not satisfied. That is, in this case, the amount of developer in the developer container 41 is reduced, and there is fear that coating of developer is not sufficient on the developing sleeve 44 or that image density fluctuation becomes significant.

Therefore, the driving speed of the developing motor 40 driving the first and second conveyance screws 46 and 47 is reduced. The developing motor 40 is capable of driving the first and second conveyance screws 46 and 47 at a first speed and a second speed slower than the first speed. Normally, that is, if the first condition is not satisfied, such as if the amount of developer in the developer container 41 is in region β, the control unit 200 drives the developing motor 40 at a first speed. Meanwhile, if the first condition is satisfied, the control unit 200 drives the developing motor 40 at a second speed. As described, if it is estimated that the amount of developer in the developer container 41 is small, the amount of discharge of developer through the discharge port of the developer container 41 is reduced, by slowing the driving speed of the first and second conveyance screws 46 and 47.

As another control for reducing the amount of developer discharged from the developer container 41, a value of toner recovery potential difference Vback, which is the difference between dark potential of electrostatic latent image applied on the surface of the photosensitive drum 1 and DC potential applied on the developing sleeve 44 may be set small. That is, if it is estimated that the amount of developer in the developer container 41 is small, there is a possibility that the amount of developer is reduced by the carrier attaching to the photosensitive drum 1. The surface of the photosensitive drum 1 is charged to a predetermined potential by applying a charging bias to the charging device 2. Meanwhile, the electrostatic latent image formed on the surface of the photosensitive drum 1 charged to a predetermined potential by the exposing unit 3 is developed by the toner by having developing bias applied to the developing sleeve 44 of the developing apparatus 4.

The potential difference between the charging bias and the developing bias (DC component) is the above-mentioned toner recovery potential difference Vback. The Vback is normally set to 150 V. If the first condition is satisfied, the Vback is set smaller than a normal state in which the Vback does not satisfy the first condition, by lowering the charging bias, raising the developing bias, or controlling both biases, such as by setting the Vback to 130 V. Thereby, the attaching of carrier to the photosensitive drum 1 can be reduced, and the reduction of the amount of developer in the developer container 41 can be suppressed. Such Vback control and control of driving speed of the first and second conveyance screws 46 and 47 can be performed simultaneously. In addition to this control, or independently from this control, it is possible to control the replenishment device to replenish the developer in the developer container 41. In any case, such control of adjustment of the amount of developer in the developer container 41 should preferably be executed while suspending image forming operation or elongating the interval of images, so-called a period between sheets, continuously formed on the photosensitive drum.

Next, if a predetermined condition of A′<0 and Δ(C−A)≧Δ(A−B), corresponding to α-low region, that is, a second condition, is satisfied, the control unit 200 suspends the image forming operation. Then, a warning is displayed on a display portion 120 (refer to FIG. 7) of the image forming apparatus 100, notifying that the amount of developer in the developer container 41 is small. If the second condition is satisfied, it is determined that the amount of developer in the developer container 41 is quite small. In that case, image defects are possibly caused by forming image in that state, so a warning is output to encourage users or service engineers to perform inspection of the developing apparatus 4 or to correct the inclination of the image forming apparatus 100.

For example, even if the first condition is satisfied, and the above-described control of Vback, the control of driving speed of the first and second conveyance screws 46 and 47 or the replenishment control are executed, the signal value of the inductance sensor 45 may not recover and the second condition may be satisfied. In that case, it can be determined that the amount of developer in the developer container 41 is quite small. In that state, the supply of developer to the developing sleeve 44 becomes unstable, and the image density fluctuation may be increased further. Therefore, in that case, the image forming operation is stopped and the above-described warning is output.

Even further, if a predetermined condition of A′>0 and D′>A′, B′ and C′, corresponding to region γ, that is, third condition, is satisfied, the electrostatic latent image is not developed by the developing apparatus 4, and the time during which the first and second conveyance screws 46 and 47 are driven is extended compared to the state where the third condition is not satisfied. That is, if the third condition is satisfied, the control unit 200 determines that the amount of developer in the developer container 41 has entered region γ and has increased. In this case, the increase in the amount of developer may cause the developer to overflow through the gap between the developer container 41 and the developing sleeve 44 or may cause the developer to retain in the vicinity of the first and second conveyance screws 46 and 47 and the bearing, locking the screws by the developer aggregating and sticking by frictional heat. Therefore, idle driving is performed to increase the amount of discharge of developer from the developer container 41. In other words, the first and second conveyance screws 46 and 47 and the developing sleeve 44 are rotated without developing an electrostatic latent image on the photosensitive drum 1. Thereby, the amount of discharge of developer from the developer container 41 can be increased, such as by attaching the developer on the photosensitive drum 1 via the developing sleeve 44, and facilitating discharge of developer through the discharge port 48 by agitating and conveying the developer by the first and second conveyance screws 46 and 47.

Specifically, in a state where the third condition is satisfied, the image forming operation is suspended and the developing motor 40 is driven for a first predetermined period of time. As another example, in a state where the third condition is satisfied, the interval between images continuously formed on the photosensitive drum 1 is elongated, and the developing motor 40 is driven for the first predetermined period of time. Of course, in that case, replenishment of developer from the replenishment device 8 will not be performed.

If the signal value of the inductance sensor 45 is not improved even if such idle rotation is executed, and the control unit 200 determines that the developer will not be discharged immediately, idle rotation is performed at a faster speed than normal. The developing motor 40 is configured to drive the first and second conveyance screws 46 and 47 at a first speed, and a third speed faster than the first speed. The control unit 200 confirms the signal value of the inductance sensor 45 again, after the first predetermined period of time has elapsed after executing idle rotation. If the third condition is still satisfied, the developing motor 40 is accelerated to the third speed and idle rotation is performed further, such that the amount of discharge of developer from the developer container 41 is increased further. If the signal value of the inductance sensor 45 still satisfies the third condition even if such idle rotation at the third speed is performed for a second predetermined period of time, a warning notifying abnormality of discharge port 48 of the developing apparatus 4 is displayed on the display portion 120.

According to the present embodiment, the fluctuation of the amount of developer in the developer container 41 can be detected and determined speedily. As a result, occurrence of overflow of developer or deterioration of developer density can be suppressed.

### Other Embodiments

An example of detecting the toner density in the developer container using an inductance sensor had been described in the embodiments illustrated above. However, the toner density can be detected by other sensors capable of detecting toner density, such as a capacitive sensor.

In the respective embodiments described above, an ACR-type configuration had been described, but the present invention can be applied to a configuration that does not adopt the ACR system. That is, the present invention can detect the change of T/D stably such as in a case where the bulk density variation of the developer in the detection area of the sensor detecting the toner density varies by causes other than the change of T/D. Therefore, the present invention can also be applied preferably to a configuration in which the driving speed of the first and second conveyance screws are varied by the change of processing speed, for example.

If the ACR-type configuration is not adopted, the developer in the developer container can be discharged in a forced manner by the developing sleeve even if a discharge port through which developer is discharged is not formed on the developer container. For example, if a predetermined electrostatic latent image is formed on the photosensitive drum, and the latent image is developed, the toner in the toner container is consumed, such that the toner density can be adjusted or the amount of discharge of developer can be increased or decreased.

In the first embodiment, a peak value of peak C is used to determine the toner density, but the toner density can be determined based on other peak values excluding peak A.

The third embodiment can be combined with the second embodiment. That is, in the third embodiment, sampling of the inductance sensor can be performed as disclosed in the second embodiment.

In the third embodiment, four peak values of output signal waveform of the inductance sensor is used to estimate the amount of developer in the developer container and control the developing apparatus appropriately, but it is also possible to estimate the amount of developer based on any one of the peaks, or peak values. For example, since the change of signal value from peak A is great in FIG. 13, the amount of developer can be estimated from the time variation of signal value of peak A. In this case, if the time variation of peak A is great, it can be determined that the amount of developer is in region α.

Further, the region in which the amount of developer belongs can be determined more accurately by considering the relation with the signal value of peak C. For example, whether the amount of developer is in region a or region γ can be determined by additionally performing a determination on whether the value of C−A is great or small. In short, if the relationship between the respective peaks and the amount of developer as illustrated in FIG. 13 is recognized, the amount of developer in the developer container can be estimated based on the time variation of the signal value of a certain peak, or the comparison of level of signal values.

The conveyance member opposed to the sensor configured to detect toner density is not restricted to a rib having a blade and ribs as mentioned above, and the present invention is applicable to any conveyance member as long as the output value of the sensor is varied periodically by the rotation of the conveyance member.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-140689, filed Jul. 15, 2016 which is hereby incorporated by reference wherein in its entirety.

What is claimed is:

1. An image forming apparatus comprising:
an image bearing member;
a developing apparatus configured to develop an electrostatic latent image formed on the image bearing member using toner, the developing apparatus comprising:
a developer container configured to store developer including nonmagnetic toner and magnetic carrier;
a developer bearing member configured to bear and convey the developer in the developer container;
a conveyance member configured to convey the developer while agitating the developer within the developer container by rotating; and
a detection unit comprising a detection surface arranged to face to the conveyance member and configured to detect a toner density concerning developer in the developer container and output a signal; and
a controller configured to adjust a toner density concerning the developer in the developer container based on a peak value of a waveform of an output signal of the detection unit.

2. The image forming apparatus according to claim 1, further comprising a replenishing portion configured to replenish developer to the developer container,
wherein the developer container comprises a discharge port through which a portion of the developer inside the developer container is discharged, and
the controller is configured to control the replenishing portion based on the peak value of the waveform of the output signal of the detection unit.

3. The image forming apparatus according to claim 1, wherein
the conveyance member comprises a plurality of projections arranged in a circumferential direction of the conveyance member such that the projections are opposed to the detection unit in a radial direction of the conveyance member, the plurality of projections having different developer conveyance capacities in the circumferential direction, and
the controller is configured to adjust the toner density based on at least one of peak values excluding a predetermined peak value from peak values appearing within one cycle of the rotation of the conveyance member, the predetermined peak value being a former peak value among peak values generated by an movement of a first projection, having a highest conveyance capacity in the circumferential direction, of the plurality of projections and appearing before and after the first projection passes a position opposed to the detection unit.

4. The image forming apparatus according to claim 3, wherein
the conveyance member comprises a rotation shaft, a blade provided on a circumference of the rotation shaft, and a rib protruded from a surface of the rotation shaft in a radial direction of the rotation shaft, the rib being arranged at a position which is different from the blade in a circumference direction of the rotation shaft and overlapping with the detection unit in a rotational axis direction of the rotation shaft, and
the first projection is the rib.

5. The image forming apparatus according to claim 1, wherein
the conveyance member is a screw comprising a rotation shaft, and a blade provided helically on the circumference of the rotation shaft, and
the controller is configured to adjust the toner density based on at least a former peak value among peak values generated by a movement of the blade and appearing before and after the blade passes an opposed position opposed to the detection unit.

6. The image forming apparatus according to claim 5, wherein the controller is configured to determine the former peak value from peak values appearing within one cycle of the rotation of the screw based on a waveform of output signal of the detection unit.

7. The image forming apparatus according to claim 1, wherein the controller is configured to adjust the toner density in the developer container based on a mean value of a plurality of peak values each of which appears at a predetermined phase within one cycle of the rotation of the conveyance members.

8. The image forming apparatus according to claim 1, wherein
the conveyance member comprises first and second projections arranged in a circumferential direction of the conveyance member, the second projection having a greater conveyance force in a rotational axis direction of the conveyance member than that of the first projection, and
the controller is configured to adjust the toner density in the developer container based on at least one of the following peak values appearing within one cycle of the rotation of the conveyance member, which are peak values generated by a movement of the first projection and appearing before and after the first projection passes an opposed position opposed to the detection surface, and peak values generated by a movement of the second projection and appearing before and after the second projection passes the opposed position.

9. The image forming apparatus according to claim 8, further comprising a driving unit configured to drive the conveyance member at a first speed and a second speed slower than the first speed,
wherein the developer container comprises a discharge port through which a portion of the developer inside the developer container is discharged, an amount of discharge from the discharge port in a state where the conveyance member is driven at the first speed is greater than the amount of discharge from the discharge port in a state where the conveyance member is driven at the second speed, and
if it is determined that an amount of developer in the developer container is smaller than a predetermined range of the amount of developer, the controller is configured to drive the driving unit at the second speed.

10. The image forming apparatus according to claim 8, wherein
the developer container comprises a discharge port through which a portion of the developer inside the developer container is discharged, and
if it is determined that an amount of developer in the developer container is greater than a predetermined range of the amount of developer, the controller is configured to set a time during which the conveyance member is driven without forming a toner image on the image bearing member longer than a time in a case where the amount of developer falls within the predetermined range.

11. The image forming apparatus according to claim 8, wherein
if a first condition is satisfied, the controller is configured to execute a control to reduce an amount of discharge of developer from the developer container compared to a state where the first condition is not satisfied,
the first condition is a condition in which an amount of change, after forming a predetermined number of images, of a first peak value is negative and an absolute value of difference between the first peak value and a second peak value is greater than an absolute value of difference between the first peak value and a third peak value at that time, and
in a state where the four peak values appear within one cycle of the rotation of the conveyance member, the first peak value is a peak value appearing latter of the two peak values appearing after the second projection passes the opposed position and before the first projection passes the opposed position, and the second peak value, the third peak value and the fourth peak value are peak values sequentially appearing after the first peak value along the rotation of the conveyance member within the one cycle of the rotation.

12. The image forming apparatus according to claim 11, further comprising a driving unit configured to drive the conveyance member at a first speed and a second speed slower than the first speed,
wherein the developer container comprises a discharge port through which a portion of the developer inside the developer container is discharged, an amount of discharge from the discharge port in a state where the conveyance member is driven at the first speed is greater than the amount of discharge from the discharge port in a state where the conveyance member is driven at the second speed, and
the controller is configured to drive the driving unit at the second speed if the first condition is satisfied.

13. The image forming apparatus according to claim 11, further comprising a charging portion configured to charge a surface of the image bearing member by applying a charging bias,
wherein the developer bearing member is configured to develop the electrostatic latent image formed on the image bearing member using toner by having a developing bias applied thereto, and
if the first condition is satisfied, the controller is configured to set a potential difference between the charging bias and the developing bias to be smaller than that in a state where the first condition is not satisfied.

14. The image forming apparatus according to claim 8, wherein
if a second condition is satisfied, the controller is configured to suspend image forming operation,
the second condition is a condition in which an amount of change, after forming a predetermined number of images, of a first peak value is negative and an absolute value of difference between the first peak value and a second peak value is equal to or smaller than an absolute value of difference between the first peak value and a third peak value at that time, and
in a state where the four peak values appear within one cycle of the rotation of the conveyance member, the first peak value is a peak value appearing latter of the two peak values appearing after the second projection passes the opposed position and before the first projection passes the opposed position, and the second peak value, the third peak value and the fourth peak value are peak values sequentially appearing after the first peak value along the rotation of the conveyance member within the one cycle of the rotation.

15. The image forming apparatus according to claim 14, further comprising a display portion configured to display a state of the image forming apparatus,
wherein if the second condition is satisfied, the controller is configured to display a warning that an amount of developer within the developer container is small on the display portion.

16. The image forming apparatus according to claim 8, wherein
if a third condition is satisfied in which an amount of change after forming a predetermined number of images of a first peak value is positive, and an amount of change after forming a predetermined number of images of a fourth peak value is greater than any one of an amount of change after forming the predetermined number of images of the first, a second and a third peak values, the controller is configured to execute control to increase an amount of developer discharged from the developer container than in a state where the third condition is not satisfied,
in the waveform of the output signal of the detection unit in which peak values respectively appear before and after the first projection and the second projection passes the opposed position opposing to the detection surface, and four such peak values appear within one cycle of the rotation of the conveyance member,
the peak value appearing latter of the two peak values appearing after the second projection passes the opposed position and before the first projection passes the opposed position comprises the first peak value, and the peak values sequentially appearing by the rotation of the conveyance member after the first peak value comprise the second peak value, the third peak value and the fourth peak value.

17. The image forming apparatus according to claim 16, wherein
the developer container comprises a discharge port through which a portion of the developer inside the developer container is discharged, and
in a state where the third condition is satisfied, the controller is configured to set a time during which the conveyance member is driven without forming a toner image on the image bearing member longer than a time in a state where the third condition is not satisfied.

18. The image forming apparatus according to claim 8, further comprising a replenishing portion configured to replenish developer to the developer container,
wherein the controller is configured to control the developing apparatus and the replenishing portion using the peak value of the waveform of the output signal of the detection unit.

19. The image forming apparatus according to claim 8, wherein
the conveyance member comprises a rotation shaft, a blade provided on a circumference of the rotation shaft, and a rib protruded from a surface of the rotation shaft in a radial direction of the rotation shaft, the rib being arranged at a position which is different from the blade in a circumference direction of the rotation shaft and overlapping with the detection unit in a rotational axis direction of the rotation shaft, and
the first projection is the rib and the second projection is the blade.

20. The image forming apparatus according to claim 1, wherein the detection unit is an inductance sensor.
